(19) United States
(12) Patent Application Publication
(10) Pub. No.: US 2026/0126579 A1
(43) Pub. Date: May 7, 2026

(54) DISPLAY DEVICE

(71) Applicant: Japan Display Inc., Tokyo (JP)

(72) Inventor: Chikyu NAKAOKA, Tokyo (JP)

(21) Appl. No.: 19/375,826

(22) Filed: Oct. 31, 2025

(30) Foreign Application Priority Data
Nov. 6, 2024 (JP) 2024-194707

(51) Int. Cl. F21V 8/00; G02F 1/13357

(52) U.S. Cl. CPC G02B 6/0053; G02F 1/133606

(57) ABSTRACT

According to an aspect, a display device includes: a first light source device configured to emit first emission light in a first direction; a second light source device configured to emit second emission light in a second direction different from the first direction; and a liquid crystal panel on which the first emission light and the second emission light are incident. The liquid crystal panel is configured to modulate the first emission light and emit, in the first direction, the modulated first emission light toward a light-transmitting body as third emission light corresponding to a first image, and modulate the second emission light to display a second image on a display surface. Luminance of the first emission light is higher than luminance of the second emission light.

### CROSS-REFERENCE TO RELATED APPLICATION

This application claims the benefit of priority from Japanese Patent Application No. 2024-194707 filed on Nov. 6, 2024, the entire contents of which are incorporated herein by reference.

### BACKGROUND

### 1. Technical Field

What is disclosed herein relates to a display device.

### 2. Description of the Related Art

As an example of a display device, Japanese Patent Application Laid-open Publication No. 2006-259043 (JP-A-2006-259043) discloses an information display device including a display unit capable of displaying two pieces of information on one screen. The display device of JP-A-2006-259043 is characterized in that one piece of the information is obtained by directly viewing the display unit, and the other piece of information is obtained through a projection surface positioned above a display surface of the display unit.

In the display device of JP-A-2006-259043, the information obtained through the projection surface is visually recognized as a virtual image. The virtual image is difficult to visually recognize when surroundings are bright, for example, in the daytime.

For the foregoing reasons, there is a need for a display device capable of allowing one of two images different from each other to be visually recognized as a virtual image and improving the visibility of the virtual image.

### SUMMARY

According to an aspect, a display device includes: a first light source device configured to emit first emission light in a first direction; a second light source device configured to emit second emission light in a second direction different from the first direction; and a liquid crystal panel on which the first emission light and the second emission light are incident. The liquid crystal panel is configured to modulate the first emission light and emit, in the first direction, the modulated first emission light toward a light-transmitting body as third emission light corresponding to a first image, and modulate the second emission light to display a second image on a display surface. Luminance of the first emission light is higher than luminance of the second emission light.

### BRIEF DESCRIPTION OF THE DRAWINGS

FIG. 1 is a schematic diagram of a display device according to a first embodiment of the present disclosure;

FIG. 2 is a plan view of a first light source device illustrated in FIG. 1;

FIG. 3 is a sectional view of the first light source device along line III-III illustrated in FIG. 2;

FIG. 4 is a sectional view of a second light source device illustrated in FIG. 1;

FIG. 5 is a sectional view of a first prism sheet and a second prism sheet along line V-V illustrated in FIG. 4;

FIG. 6 is a conceptual diagram of a liquid crystal panel illustrated in FIG. 1;

FIG. 7 is a plan view of the liquid crystal panel illustrated in FIG. 1;

FIG. 8 is a diagram illustrating an arrangement of first and second sub pixels illustrated in FIG. 7;

FIG. 9 is a diagram illustrating a circuit configuration of the liquid crystal panel illustrated in FIG. 7;

FIG. 10 is a sectional view of the liquid crystal panel illustrated in FIG. 7;

FIG. 11 is a plan view of a parallax barrier illustrated in FIG. 10;

FIG. 12 is a diagram illustrating luminance distribution of first emission light and second emission light;

FIG. 13 is a schematic diagram of a display device according to a second embodiment of the present disclosure;

FIG. 14 is a sectional view of the second light source device illustrated in FIG. 13;

FIG. 15 is a diagram illustrating an arrangement of the first and second sub pixels of the liquid crystal panel included in a display device according to a modification of each embodiment of the present disclosure; and

FIG. 16 is a plan view of the parallax barrier of the liquid crystal panel included in the display device according to the modification of each embodiment of the present disclosure.

### DETAILED DESCRIPTION

An embodiment of the present disclosure is described below with reference to the drawings. Contents described below in the embodiments do not limit the present disclosure. Components described below include those that could be easily thought of by the skilled person in the art and those identical in effect. Components described below may be combined as appropriate.

What is disclosed herein is only an example, and any modifications that can be easily conceived by those skilled in the art while maintaining the main purpose of the present disclosure are naturally included in the scope of the present disclosure. The drawings may be schematically represented in terms of the width, thickness, shape, etc. of each part compared to those in the actual form for the purpose of clearer explanation, but they are only examples and do not limit the interpretation of the present disclosure. In the present specification and the drawings, the same reference sign is applied to the same elements as those already described for the previously mentioned drawings, and detailed explanations may be omitted as appropriate.

X, Y, and Z directions illustrated in the drawings correspond to the front-back, right-left, and up-down directions of a display device 1. The X, Y, and Z directions are orthogonal to each other. In the X direction, the side indicated by an arrow is the positive X side, and the opposite side is the negative X side. In the Y direction, the side indicated by an arrow is the positive Y side, and the opposite side is the negative Y side. In the Z direction, the side indicated by an arrow is the positive Z side (upper side), and the opposite side is the negative Z side (lower side). The X, Y, and Z directions are exemplary, and the present disclosure is not limited to these directions.

### First Embodiment

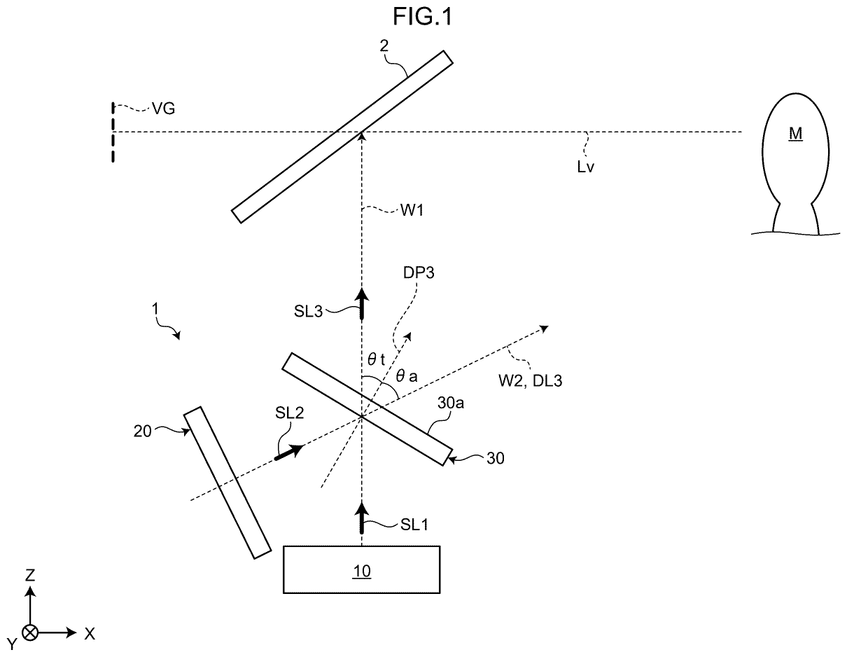

FIG. 1 is a schematic diagram of the display device 1 according to a first embodiment of the present disclosure.

The display device 1 projects a first image onto a light-transmitting body 2, thereby allowing a viewer M to visually recognize a virtual image VG corresponding to the first image. The light-transmitting body 2 is plate-shaped and has a light-transmitting property. The light-transmitting body 2 is, for example, a windshield or a combiner of a vehicle but not limited to the windshield and the combiner, and may have any structure onto which an image output from the display device 1 is projected.

The display device 1 displays a second image on a display surface 30a of a liquid crystal panel 30 to be described later. The viewer M can visually recognize the second image by viewing the display surface 30a.

The display device 1 includes a first light source device 10, a second light source device 20, and the liquid crystal panel 30.

The first light source device 10 is disposed on the negative Z side relative to the liquid crystal panel 30. The first light source device 10 emits first emission light SL1. The optical axis of the first emission light SL1 extends in a first direction W1. The first direction W1 is parallel to the Z direction. The first direction W1 may be tilted relative to the Z direction.

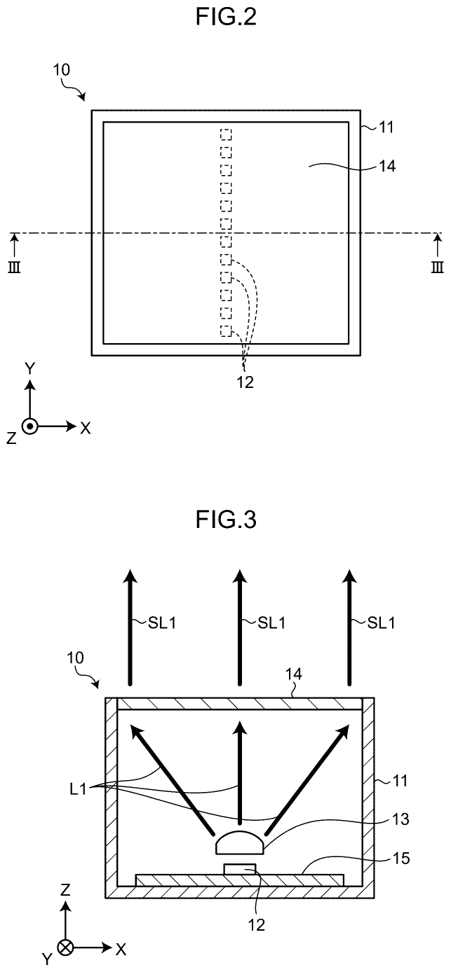

FIG. 2 is a plan view of the first light source device 10 illustrated in FIG. 1. FIG. 3 is a sectional view of the first light source device 10 along line III-III illustrated in FIG. 2.

The first light source device 10 is what is called a direct-type backlight. The first light source device 10 includes a housing 11, a plurality of first light emitters 12, a first lens 13, and a plate-shaped second lens 14 (corresponding to “lens”).

The first light emitters 12 are disposed on a substrate 15 positioned at a bottom of the housing 11. The first light emitters 12 are arranged in a line in a direction (in the first embodiment, the Y direction) orthogonal to the first direction W1. Each first light emitter 12 is, for example, a light emitting diode (LED). Each first light emitter 12 emits first light L1 toward the first lens 13.

A plurality of the first lenses 13 are housed in the housing 11. The number of the first lenses 13 is equal to the number of the first light emitters 12. The first lens 13 is disposed so as to overlap the first light emitters 12 in the Z direction. The first lenses 13 are diffusion lenses. The first lenses 13 diffuse the first light L1 emitted from the first light emitters 12 in each of the X and Y directions and emit the light toward the second lens 14. Through the first lenses 13, the diffusion degree of the first light L1 in the X direction is larger than the diffusion degree of the first light L1 in the Y direction. This makes it possible to achieve uniformity in distribution of the first light L1 incident on the second lens 14.

The second lens 14 refracts the first light L1 from the first lenses 13 to collimate the light in the first direction W1 (Z direction). The second lens 14 is, for example, a Fresnel lens including a combination of a plurality of convex lenses. The collimated light from the second lens 14 corresponds to the first emission light SL1 of the first light source device 10. In other words, the second lens 14 refracts the first light L1 emitted from the first light emitters 12 to align the light in the first direction W1 and emits the light as the first emission light SL1. The first emission light SL1 travels in the first direction W1.

In this manner, the first light source device 10 includes the second lens 14, thereby reducing the diffusion degree of the first emission light SL1 as compared to a case where the first light source device 10 does not include the second lens 14. Consequently, the luminance of the first emission light SL1 is increased. The first light source device 10 does not need to include the first lenses 13.

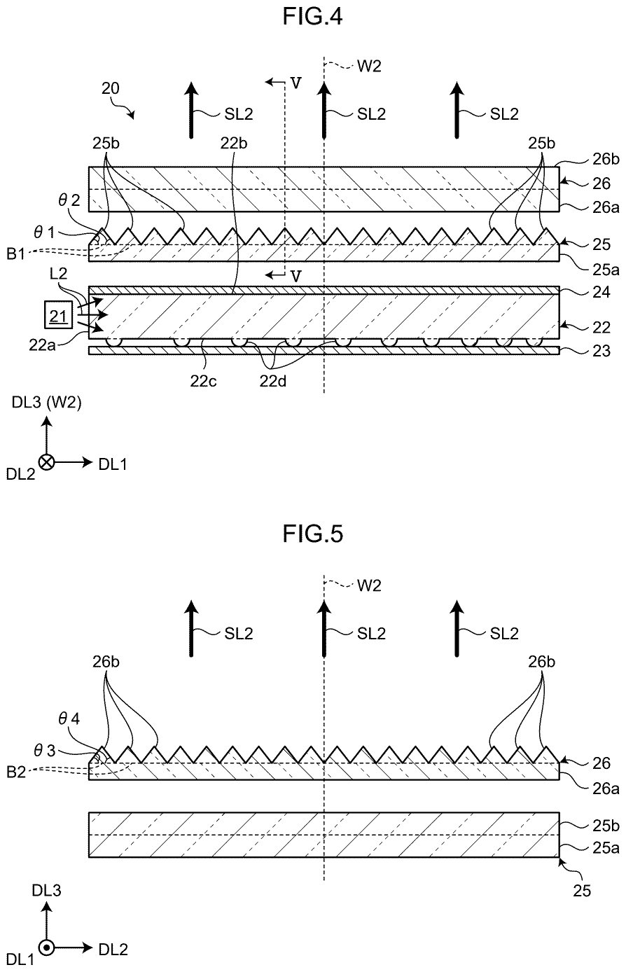

FIG. 4 is a sectional view of the second light source device 20 illustrated in FIG. 1. A first light source direction DL1, a second light source direction DL2, and a third light source direction DL3 illustrated in the drawings are orthogonal to each other. The first light source direction DL1 corresponds to the width direction of the second light source device 20, the second light source direction DL2 corresponds to the depth direction, and the third light source direction DL3 corresponds to the vertical direction. In the first light source direction DL1, the side indicated by an arrow corresponds to the positive DL1 side of the second light source device 20, and the opposite side thereof corresponds to the negative DL1 side of the second light source device 20. In the second light source direction DL2, the side indicated by an arrow corresponds to the positive DL2 side of the second light source device 20, and the opposite side thereof corresponds to the negative DL2 side of the second light source device 20. In the third light source direction DL3, the side indicated by an arrow corresponds to the positive DL3 side (upper side) of the second light source device 20, and the opposite side thereof corresponds to the negative DL3 side (lower side) of the second light source device 20. The first light source direction DL1, the second light source direction DL2, and the third light source direction DL3 are exemplary, and the present disclosure is not limited to these directions.

The second light source device 20 is what is called an edge-lit backlight. The second light source device 20 includes a second light emitter 21, a light guiding member 22, a reflection sheet 23, a diffusion sheet 24, a first prism sheet 25, and a second prism sheet 26. The first prism sheet 25 and the second prism sheet 26 correspond to a “prism sheet”.

A plurality of the second light emitters 21 are arranged in the second light source direction DL2. Each second light emitter 21 is, for example, a light emitting diode (LED). Each second light emitter 21 emits second light L2 toward the light guiding member 22.

The light guiding member 22 is plate-shaped and has a side plate surface 22a, a first plate surface 22b (corresponding to a “plate surface”), and a second plate surface 22c located opposite the first plate surface 22b. The side plate surface 22a is a surface of the light guiding member 22 facing the negative DL1 side. The first plate surface 22b is a surface of the light guiding member 22 on the positive DL3 side. The second plate surface 22c is a surface of the light guiding member 22 on the negative DL3 side. The first plate surface 22b and the second plate surface 22c are orthogonal to the third light source direction DL3. The light guiding member 22 has a plurality of protruding portions 22d on the second plate surface 22c.

The light guiding member 22 has a light-transmitting property. The second light L2 emitted from the second light emitters 21 is incident into the light guiding member 22 through the side plate surface 22a. The second light L2 incident into the light guiding member 22 is reflected at the inner surface of the light guiding member 22. The second light L2 is emitted from the first plate surface 22b upon reflection at the protruding portions 22d. Thus, the shapes and positions of the protruding portions 22d are determined such that the second light L2 is emitted from the first plate surface 22b. The protruding portions 22d are semicircular in section, but may be triangular in section.

The reflection sheet 23 is disposed on the second plate surface 22c side of the light guiding member 22. The reflection sheet 23 is, for example, a metal film having relatively high reflectance, such as aluminum or silver. The reflection sheet 23 reflects the second light L2 emitted from the second plate surface 22c toward the light guiding member 22. The reflection sheet 23 suppresses a decrease in the luminance of the second light L2 emitted from the first plate surface 22b.

The diffusion sheet 24 is disposed on the first plate surface 22b side of the light guiding member 22. The diffusion sheet 24 diffuses the second light L2 emitted from the first plate surface 22b. With the diffusion sheet 24, uniformity in the luminance of the second light L2 emitted from the first plate surface 22b can be achieved.

FIG. 5 is a sectional view of the first prism sheet 25 and the second prism sheet 26 along line V-V illustrated in FIG. 4.

The first prism sheet 25 and the second prism sheet 26 illustrated in FIGS. 4 and 5 refract the second light L2 emitted from the first plate surface 22b to align the light in a second direction W2 and emit the light as second emission light SL2. The optical axis of the second emission light SL2 extends along the second direction W2. In the first embodiment, the second direction W2 is parallel to the third light source direction DL3.

The first prism sheet 25 is disposed on the positive DL3 side of the light guiding member 22 and the diffusion sheet 24. The first prism sheet 25 includes a plate-shaped first base part 25a and a plurality of first prism parts 25b.

The first prism parts 25b are disposed on a surface of the first base part 25a on the positive DL3 side. The first prism parts 25b are triangular in section, extend in the second light source direction DL2, and are disposed in a state in which their bases B1 are adjacent to each other in the first light source direction DL1. The sectional shape of each first prism part 25b is an isosceles triangle. Specifically, in the sectional shape of each first prism part 25b, a first bottom angle θ1 and a second bottom angle θ2 are equal to each other. The first bottom angle θ1 and the second bottom angle θ2 are determined such that the second light L2 traveling in the first light source direction DL1 is refracted into the second direction W2 through the first prism part 25b.

Accordingly, the first prism sheet 25 refracts the second light L2 traveling in the first light source direction DL1 into the second direction W2. In other words, the first prism sheet 25 refracts the second light L2 in the second direction W2 when viewed along the second light source direction DL2.

The second prism sheet 26 is disposed on the positive DL3 side of the first prism sheet 25. The second prism sheet 26 includes a plate-shaped second base part 26a and a plurality of second prism parts 26b.

The second prism parts 26b are disposed on a surface of the second base part 26a on the positive DL3 side. The second prism parts 26b are triangular in section, extend in the first light source direction DL1, and are disposed in a state in which their bases B2 are adjacent to each other in the second light source direction DL2. The sectional shape of each second prism part 26b is an isosceles triangle. Specifically, in the sectional shape of each second prism part 26b, a third bottom angle θ3 and a fourth bottom angle θ4 are equal to each other. The third bottom angle θ3 and the fourth bottom angle θ4 are determined such that the second light L2 traveling in the second light source direction DL2 is refracted into the second direction W2 through the second prism part 26b.

Accordingly, the second prism sheet 26 refracts the second light L2 traveling in the second light source direction DL2 into the second direction W2. In other words, the second prism sheet 26 refracts the second light L2 into the second direction W2 when viewed along the first light source direction DL1. The second light L2 emitted from the second prism sheet 26 corresponds to the second emission light SL2.

As illustrated in FIG. 1, the second light source device 20 is positioned on the negative X side relative to the liquid crystal panel 30 where the second light source device 20 does not overlap the first light source device 10 and the liquid crystal panel 30 when viewed along the Z direction. The second light source device 20 is disposed such that the first direction W1 and the second direction W2 are different from each other. Specifically, the second light source device 20 is disposed in a state in which the second light source direction DL2 is parallel to the Y direction and the third light source direction DL3 is tilted relative to the Z direction. In this manner, the second light source device 20 emits the second emission light SL2 in the second direction W2 different from the first direction W1.

As described above, the first light source device 10 is a direct-type backlight, and the second light source device 20 is an edge-lit backlight. Accordingly, the luminance of the first emission light SL1 of the first light source device 10 is higher than the luminance of the second emission light SL2 of the second light source device 20.

Specifically, for example, the luminance and number of the first light emitters 12, the luminance and number of the second light emitters 21, and the specifications of the light guiding member 22, the reflection sheet 23, the diffusion sheet 24, the first prism sheet 25, and the second prism sheet 26 are determined such that the luminance of the first emission light SL1 is higher than the luminance of the second emission light SL2. Moreover, it is possible to increase the luminance of the first emission light SL1 with the second lens 14 of the first light source device 10.

The diffusion degree of the second emission light SL2 is larger than the diffusion degree of the first emission light SL1. Specifically, for example, the characteristics of the second lens 14 and the specifications of the light guiding member 22, the diffusion sheet 24, the first prism sheet 25, and the second prism sheet 26 are determined such that the diffusion degree of the second emission light SL2 is larger than the diffusion degree of the first emission light SL1.

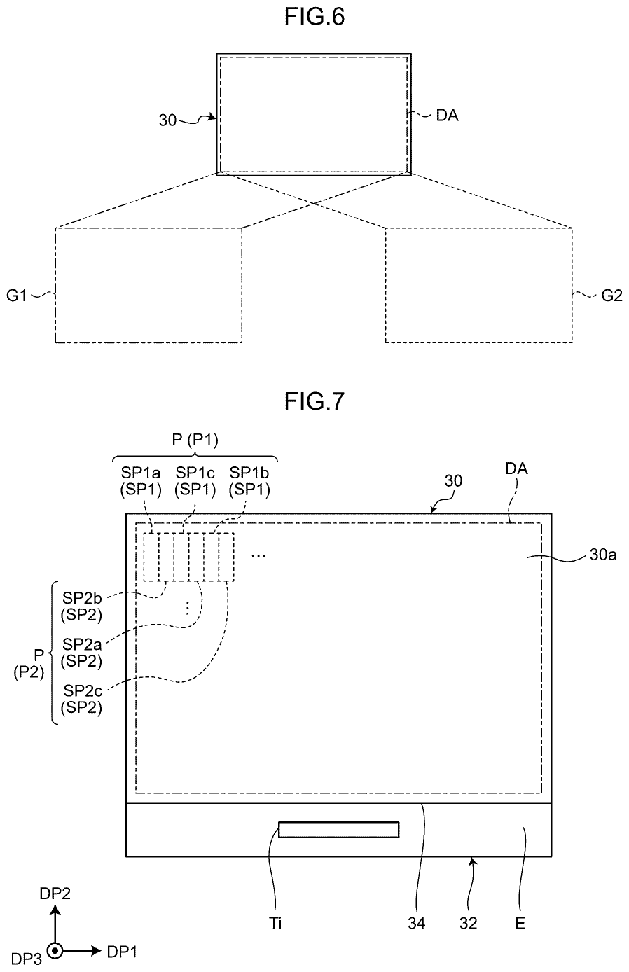

FIG. 6 is a conceptual diagram of the liquid crystal panel 30 illustrated in FIG. 1. A first image G1 and a second image G2 are simultaneously displayed in an entire display region DA of the liquid crystal panel 30 at viewing angles different from each other.

FIG. 7 is a plan view of the liquid crystal panel 30 illustrated in FIG. 1. A first panel direction DP1, a second panel direction DP2, and a third panel direction DP3 illustrated in the drawing are orthogonal to each other. The first panel direction D1 corresponds to the width direction of the liquid crystal panel 30, the second panel direction D2 to the depth direction, and the third panel direction D3 to the vertical direction. In the first panel direction DP1, the side indicated by an arrow corresponds to the positive DP1 side of the liquid crystal panel 30, and the opposite side corresponds to the negative DP1 side of the liquid crystal panel 30. In the second panel direction DP2, the side indicated by an arrow corresponds to the positive DP2 side of the liquid crystal panel 30, and the opposite side corresponds to the negative DP2 side of the liquid crystal panel 30. In the third panel direction DP3, the side indicated by an arrow corresponds to the positive DP3 side (upper side) of the liquid crystal panel 30, and the opposite side corresponds to the negative DP3 side (lower side) of the liquid crystal panel 30. The first panel direction DP1, the second panel direction DP2, and the third panel direction DP3 are exemplary, and the present disclosure is not limited to these directions.

The liquid crystal panel 30 is disposed such that the second panel direction DP2 and the Y direction are parallel to each other and the third panel direction DP3 and the first direction W1 are tilted to each other (refer to FIG. 1). The liquid crystal panel 30 is also disposed such that the third panel direction DP3 and the second direction W2 are tilted to each other. The liquid crystal panel 30 may be disposed such that the third panel direction DP3 and the second direction W2 are parallel to each other.

The liquid crystal panel 30 displays an image based on an image signal output from an external device (for example, car navigation system) electrically coupled thereto through a flexible wiring board (not illustrated).

The liquid crystal panel 30 is a transmissive liquid crystal display. The liquid crystal panel 30 may be, for example, an organic or inorganic EL display. As illustrated in FIG. 7, the liquid crystal panel 30 has the display region DA in which an image is displayed on the display surface 30a. The display surface 30a is flat and planar. The display surface 30a is orthogonal to the third panel direction DP3.

The liquid crystal panel 30 includes a plurality of pixels P disposed in a matrix of rows and columns in plan view. The row direction is parallel to the first panel direction DP1. The column direction is parallel to the second panel direction DP2. The pixels P overlap the display region DA in plan view of the liquid crystal panel 30. The pixels P include a plurality of first pixels P1 and a plurality of second pixels P2.

The first pixels P1 are pixels corresponding to the first image G1. Each first pixel P1 includes a first-type first sub pixel SP1a, a second-type first sub pixel SP1b, and a third-type first sub pixel SP1c. The first-type first sub pixel SP1a is a red sub pixel. The second-type first sub pixel SP1b is a green sub pixel. The third-type first sub pixel SP1c is a blue sub pixel. Hereinafter, the first-type first sub pixel SP1a, the second-type first sub pixel SP1b, and the third-type first sub pixel SP1c are simply referred to as “first sub pixels SP1” when not distinguished in description.

The second pixels P2 are pixels corresponding to the second image G2. Each second pixel P2 includes a first-type second sub pixel SP2a, a second-type second sub pixel SP2b, and a third-type second sub pixel SP2c. The first-type second sub pixel SP2a is a red sub pixel. The second-type second sub pixel SP2b is a green sub pixel. The third-type second sub pixel SP2c is a blue sub pixel. Hereinafter, the first-type second sub pixel SP2a, the second-type second sub pixel SP2b, and the third-type second sub pixel SP2c are simply referred to as “second sub pixels SP2” when not distinguished in description.

In this manner, each first pixel P1 includes the three first sub pixels SP1, and each second pixel P2 includes the three second sub pixels SP2. The number and colors of the first sub pixels SP1 and the number and colors of the second sub pixels SP2 are not limited to the above-described numbers and colors.

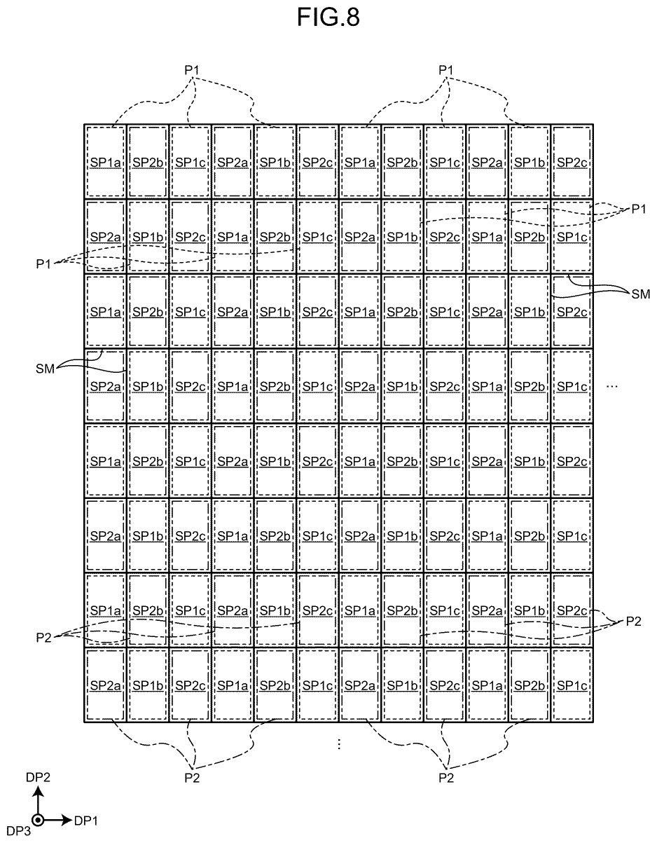

FIG. 8 is a diagram illustrating an arrangement of the first sub pixels SP1 and the second sub pixels SP2 illustrated in FIG. 7. In FIG. 8, each first sub pixel SP1 is indicated with a quadrilateral shape illustrated by dashed lines, and each second sub pixel SP2 is indicated with a quadrilateral shape illustrated by dashed and single-dotted lines.

The first pixels P1 and the second pixels P2 are each disposed in the row direction (first panel direction DP1). The first pixels P1 and the second pixels P2 are each disposed in zigzag shapes in the column direction (second panel direction DP2).

Focusing on the first pixels P1 arranged in the row direction, the first-type first sub pixel SP1a, the third-type first sub pixel SP1c, and the second-type first sub pixel SP1b are repeatedly disposed in the stated order in the row direction. Focusing on the second pixels P2 arranged in the row direction, the second-type second sub pixel SP2b, the first-type second sub pixel SP2a, and the third-type second sub pixel SP2c are repeatedly disposed in the stated order in the row direction.

Moreover, the first sub pixels SP1 and the second sub pixels SP2 are alternately arranged in the row direction. That is, the first sub pixel SP1 and the second sub pixel SP2 are adjacent to each other in the row direction. Specifically, the first-type first sub pixel SP1a is adjacent to at least one of the second-type second sub pixel SP2b and the third-type second sub pixel SP2c in the row direction. The second-type first sub pixel SP1b is adjacent to at least one of the third-type second sub pixel SP2c and the first-type second sub pixel SP2a in the row direction. The third-type first sub pixel SP1c is adjacent to at least one of the first-type second sub pixel SP2a and the second-type second sub pixel SP2b in the row direction.

The first-type second sub pixel SP2a is adjacent to at least one of the second-type first sub pixel SP1b and the third-type first sub pixel SP1c in the row direction. The second-type second sub pixel SP2b is adjacent to at least one of the third-type first sub pixel SP1c and the first-type first sub pixel SP1a in the row direction. The third-type second sub pixel SP2c is adjacent to at least one of the first-type first sub pixel SP1a and the second-type first sub pixel SP1b in the row direction.

The first sub pixels SP1 and the second sub pixels SP2 are alternately arranged in the column direction. That is, the first sub pixels SP1 and the second sub pixels SP2 are adjacent to each other in the column direction. Specifically, the first-type first sub pixel SP1a and the first-type second sub pixel SP2a are alternately arranged in the column direction. The second-type first sub pixel SP1b and the second-type second sub pixel SP2b are alternately arranged in the column direction. The third-type first sub pixel SP1c and the third-type second sub pixel SP2c are alternately arranged in the column direction.

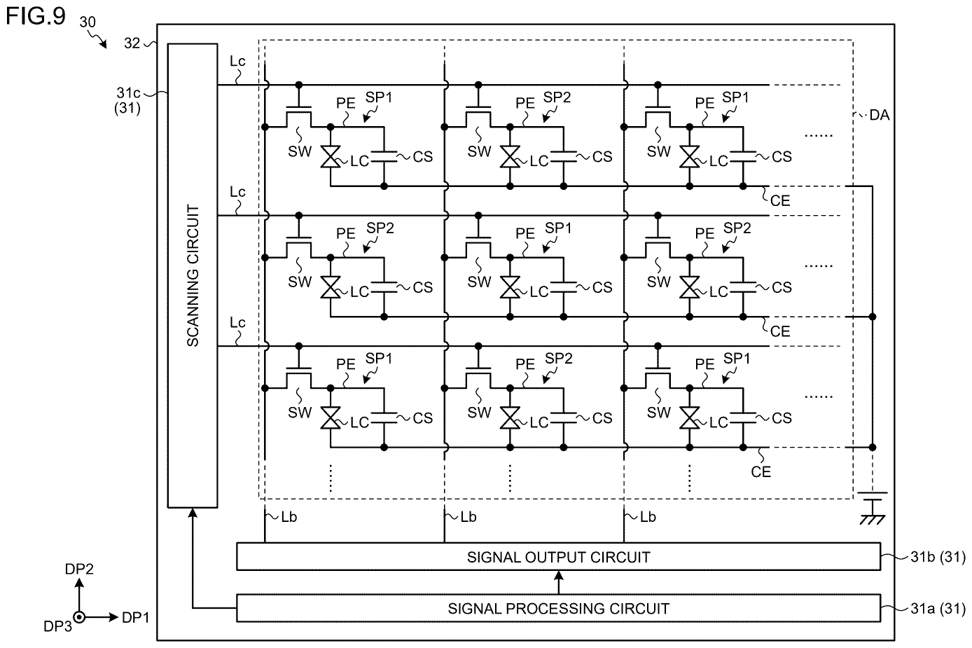

FIG. 9 is a diagram illustrating a circuit configuration of the liquid crystal panel 30 illustrated in FIG. 7. The liquid crystal panel 30 includes a drive circuit 31, and a switching element SW, a sub pixel electrode PE, a common electrode CE, a liquid crystal capacitor (capacitance) LC, and a storage capacitor CS provided in each of the first sub pixels SP1 and the second sub pixels SP2. The first sub pixels SP1 and the second sub pixels SP2 are configured in the same manner.

The drive circuit 31 drives the liquid crystal panel 30. The drive circuit 31 includes a signal processing circuit 31a, a signal output circuit 31b, and a scanning circuit 31c.

The signal processing circuit 31a outputs first sub pixel signals indicating the gradations of the first sub pixels SP1 and second sub pixel signals indicating the gradations of the second sub pixels SP2 to the signal output circuit 31b based on an image signal transmitted from an external device. The signal processing circuit 31a also outputs a clock signal synchronizing operation of the signal output circuit 31b and operation of the scanning circuit 31c to the signal output circuit 31b and the scanning circuit 31c.

The signal output circuit 31b outputs the first sub pixel signals to the first sub pixels SP1 and outputs the second sub pixel signals to the second sub pixels SP2. The signal output circuit 31b is electrically coupled to the first sub pixels SP1 and the second sub pixels SP2 through a plurality of signal lines Lb extending in the second panel direction DP2.

The scanning circuit 31c scans the first sub pixels SP1 and the second sub pixels SP2 in synchronization with the outputting of the first sub pixel signals and the second sub pixel signals from the signal output circuit 31b. The scanning circuit 31c is electrically coupled to the first sub pixels SP1 and the second sub pixels SP2 through a plurality of scanning lines Lc extending in the first panel direction DP1.

In a plan view of the display surface 30a, a region partitioned by two signal lines Lb adjacent to each other in the first panel direction DP1 and two scanning lines Lc adjacent to each other in the second panel direction DP2 corresponds to one of the first sub pixels SP1 and the second sub pixels SP2.

The switching element SW includes, for example, a thin film transistor (TFT). The switching element SW has a source electrode electrically coupled to a signal line Lb, and a gate electrode electrically coupled to a scanning line Lc.

The sub pixel electrode PE is coupled to a drain electrode of the switching element SW. A plurality of the common electrodes CE are disposed corresponding to the scanning lines Lc. The sub pixel electrode PE and the common electrode CE have a light-transmitting property.

The liquid crystal capacitor (capacitance) LC is a capacitive component of a liquid crystal material of a liquid crystal layer 33 to be described later between the sub pixel electrode PE and the common electrode CE. The storage capacitor CS is disposed between an electrode at the same potential as the common electrode CE and an electrode at the same potential as the sub pixel electrode PE.

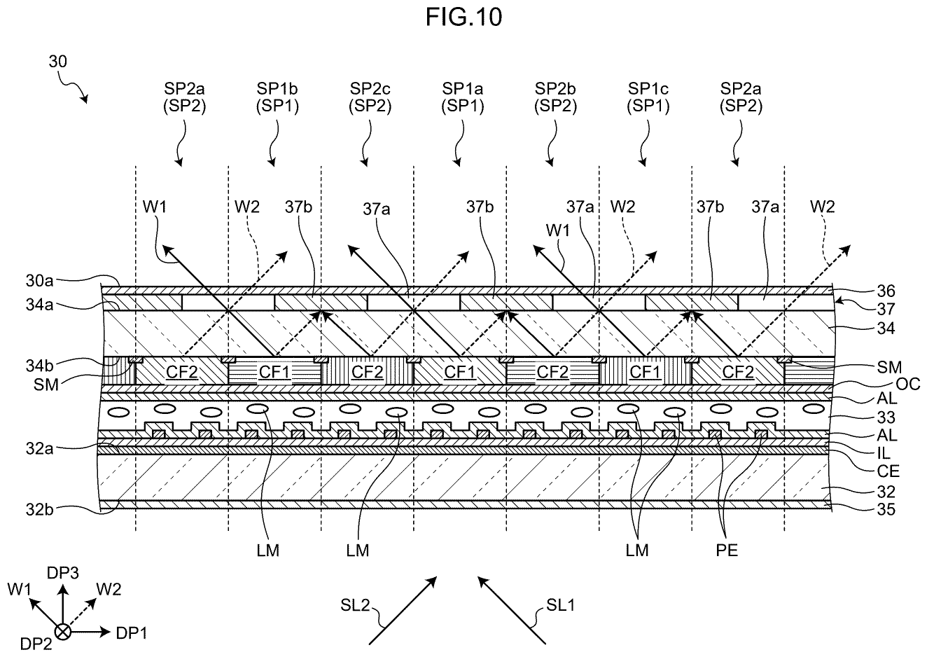

FIG. 10 is a sectional view of the liquid crystal panel 30 illustrated in FIG. 7. The liquid crystal panel 30 further includes a first substrate 32, the liquid crystal layer 33, and a second substrate 34. The first substrate 32, the liquid crystal layer 33, and the second substrate 34 have light-transmitting properties and are disposed in the stated order from the negative DP3 side toward the positive DP3 side in the third panel direction DP3. The first substrate 32 and the second substrate 34 have quadrilateral shapes in plan view. The shapes of the first substrate 32 and the second substrate 34 in plan view may be other than quadrilateral shapes, such as circular or trapezoid shapes.

The common electrode CE is disposed on a principal surface 32a of the first substrate 32 on the positive DP3 side. An insulating layer IL is disposed on the positive DP3 side of the common electrode CE, and in addition, the sub pixel electrode PE and an alignment film AL are disposed thereon.

The sub pixel electrode PE is disposed between the insulating layer IL and the alignment films AL. In this manner, the common electrode CE and the sub pixel electrode PE are disposed on the first substrate 32. That is, the liquid crystal panel 30 is a liquid crystal display of a horizontal electric field type.

The second substrate 34 is positioned on the positive DP3 side of the first substrate 32. An overcoat layer OC, first color filters CF1, second color filters CF2, a light-shielding film SM, and an alignment film AL are disposed on a lower surface 34b side of the second substrate 34. The light-shielding film SM, the first color filters CF1, the second color filters CF2, and the overcoat layer OC are disposed between the second substrate 34 and the alignment film AL.

The overcoat layer OC is formed of a material having a light-transmitting property.

The first color filters CF1 and the second color filters CF2 are disposed between the second substrate 34 and the liquid crystal layer 33. The first color filters CF1 are color filters included in the first sub pixels SP1. The second color filters CF2 are color filters included in the second sub pixels SP2.

The first color filters CF1 and the second color filters CF2 have quadrilateral shapes in plan view. Each of the first color filters CF1 and the second color filters CF2 has a light-transmitting property and has a predetermined peak of the spectrum of light to be transmitted. The spectrum peak corresponds to the color of a corresponding one of the first color filters CF1 and the second color filters CF2. That is, light transmitted through the first color filters CF1 and the second color filters CF2 is colored. The shapes of the first color filters CF1 and the second color filters CF2 in plan view may be changed so as to match the shapes of the first sub pixels SP1 and the second sub pixels SP2.

The colors of the first color filters CF1 are the same as the colors of the first sub pixels SP1. The colors of the second color filters CF2 are the same as the colors of the second sub pixels SP2. Specifically, each red first-type first sub pixel SP1a includes a red first color filter CF1, each green second-type first sub pixel SP1b includes a green first color filter CF1, and each blue third-type first sub pixel SP1c includes a blue first color filter CF1. Each red first-type second sub pixel SP2a includes a red second color filter CF2, each green second-type second sub pixel SP2b includes a green second color filter CF2, and each blue third-type second sub pixel SP2c includes a blue second color filter CF2.

The light-shielding film SM is light-shielding and overlaps the boundary of a first sub pixel SP1 and the boundary of a second sub pixel SP2 adjacent to each other in the first panel direction DP1 and the second panel direction DP2 in the plan view of the display surface 30a. In other words, the light-shielding film SM overlaps the signal lines Lb and the scanning lines Lc in the plan view of the display surface 30a. In FIG. 9, illustrations of the signal lines Lb and the scanning lines Lc are omitted. The signal lines Lb and the scanning lines Lc are disposed on the principal surface 32a of the first substrate 32. In FIG. 8, solid lines partitioning the first sub pixels SP1 and the second sub pixels SP2 correspond to the light-shielding film SM. The peripheries of the first color filters CF1 and the peripheries of the second color filters CF2 overlap the light-shielding film SM in the plan view of the display surface 30a.

As illustrated in FIG. 10, the liquid crystal layer 33 is disposed between the first substrate 32 and the second substrate 34. The liquid crystal layer 33 contains a plurality of liquid crystal molecules LM. The liquid crystal layer 33 overlaps the display region DA in the plan view of the display surface 30a. Specifically, the liquid crystal layer 33 is disposed between the two alignment films AL facing each other. The initial alignment of the liquid crystal molecules LM is determined by the two alignment films AL facing each other.

The liquid crystal panel 30 further includes a first polarizing plate 35, a second polarizing plate 36, and a parallax barrier 37.

The first polarizing plate 35 is disposed on a lower surface 32b of the first substrate 32. A surface of the first polarizing plate 35 on the negative D3 side corresponds to the lower surface of the liquid crystal panel 30. As illustrated in FIG. 1, the lower surface of the liquid crystal panel 30 faces the first light source device 10. The first emission light SL1 enters the liquid crystal panel 30 along the first direction W1 through the lower surface, and in addition, the second emission light SL2 enters the liquid crystal panel 30 along the second direction W2 through the lower surface.

As illustrated in FIG. 10, the second polarizing plate 36 is disposed on an upper surface 34a of the second substrate 34. A transmission axis of the second polarizing plate 36 is orthogonal to the transmission axis of the first polarizing plate 35. A surface of the second polarizing plate 36 on the positive DP3 side corresponds to the display surface 30a.

The parallax barrier 37 is disposed between the second substrate 34 and the second polarizing plate 36. The parallax barrier 37 is plate-shaped. The parallax barrier 37 is disposed on the surface (upper surface 34a) of the second substrate 34 on the side opposite a surface (the lower surface 34b) facing the first color filters CF1 and the second color filters CF2. The parallax barrier 37 includes a plurality of openings 37a and a light-shielding part 37b.

The openings 37a pass light traveling in the first direction W1 among light transmitted through the first color filters CF1 of the first sub pixels SP1. The first direction W1 is indicated by solid lines in FIG. 10. The openings 37a also pass light traveling in the second direction W2 among light transmitted through the second color filters CF2 of the second sub pixels SP2. The second direction W2 is indicated by dashed lines in FIG. 10.

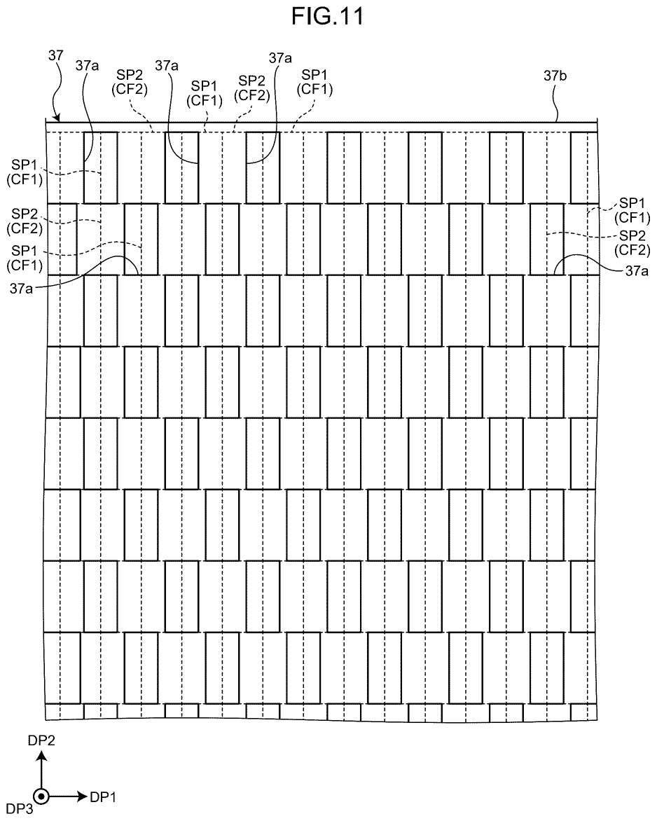

FIG. 11 is a plan view of the parallax barrier 37 illustrated in FIG. 10. In FIG. 11, the first sub pixels SP1 and the second sub pixels SP2 are illustrated with dashed lines. As illustrated in FIGS. 10 and 11, in the plan view of the display surface 30a, each opening 37a overlaps the first color filter CF1 of a first sub pixel SP1 and the second color filter CF2 of a second pixel P2 adjacent to each other in the row direction. In the plan view illustrated in FIG. 11, each opening 37a overlaps the negative DP1 side of a first color filter CF1 and the positive DP1 side of a second color filter CF2.

As illustrated in FIG. 11, the openings 37a are disposed in the row direction in the plan view of the display surface 30a. The openings 37a are also disposed in zigzag shapes in the column direction in plan view.

The light-shielding part 37b illustrated in FIGS. 10 and 11 is formed of a material with high light absorption (for example, metallic chromium (Cr), chromium oxide (CrO₂), or resin). The light-shielding part 37b blocks light traveling in the second direction W2 among light transmitted through the first color filters CF1 of the first sub pixels SP1. The light-shielding part 37b also blocks light traveling in the first direction W1 among light transmitted through the second color filters CF2 of the second sub pixels SP2.

As illustrated in FIG. 7, the first substrate 32 includes an exposed part E that is exposed from the second substrate 34 in plan view. The exposed part E is positioned on the negative DP2 side relative to the second substrate 34 in plan view. An IC chip Ti including the drive circuit 31 is disposed on the upper surface of the exposed part E. A surface of the exposed part E on the positive DP3 side is part of the principal surface 32a of the first substrate 32.

The following describes operation of the display device 1.

As illustrated in FIG. 1, the first light source device 10 emits the first emission light SL1 in the first direction W1 toward the liquid crystal panel 30. In addition, the second light source device 20 emits the second emission light SL2 in the second direction W2 toward the liquid crystal panel 30.

Upon acquiring an image signal transmitted from an external device, the liquid crystal panel 30 illustrated in FIG. 10 displays the first image G1 and the second image G2 in the display region DA as described below.

The image signal includes the gradations of the first sub pixels SP1 corresponding to the first image G1 and the gradations of the second sub pixels SP2 corresponding to the second image G2. As described above, the first sub pixel signals indicating the gradations of the first sub pixels SP1 are output to the first sub pixels SP1, and the second sub pixel signals indicating the gradations of the second sub pixels SP2 are output to the second sub pixels SP2.

Voltages corresponding to the gradations indicated by the first sub pixel signals are applied to regions of the liquid crystal layer 33 corresponding to the first sub pixels SP1, and the liquid crystal molecules LM are tilted. The degree of tilt of the liquid crystal molecules LM changes with the gradations indicated by the first sub pixel signals. The first emission light SL1 and the second emission light SL2 transmitted through the regions of the liquid crystal layer 33 corresponding to the first sub pixels SP1 are modulated to the gradations indicated by the first sub pixel signals. In addition, the first emission light SL1 and the second emission light SL2 transmitted through the regions of the liquid crystal layer 33 corresponding to the first sub pixels SP1 are colored by being transmitted through the first color filters CF1. The first emission light SL1 and the second emission light SL2 transmitted through the liquid crystal panel 30 via the first color filters CF1 correspond to the first image G1.

Of the first emission light SL1 and the second emission light SL2 transmitted through the first color filters CF1, the second emission light SL2 travels in the second direction W2 and is blocked by the light-shielding part 37b. Accordingly, the second emission light SL2 transmitted through the first color filters CF1 is not visual recognizable.

However, of the first emission light SL1 and the second emission light SL2 transmitted through the first color filters CF1, the first emission light SL1 travels in the first direction W1, passes through the openings 37a of the parallax barrier 37, and is externally emitted from the display surface 30a. Hereinafter, the first emission light SL1 emitted from the display surface 30a is referred to as third emission light SL3.

The third emission light SL3 corresponds to the first image G1. The third emission light SL3 travels in the first direction W1 toward the light-transmitting body 2 (refer to FIG. 1). In this manner, the liquid crystal panel 30 modulates the first emission light SL1 and emits the modulated first emission light SL1 toward the light-transmitting body 2 in the first direction W1 as the third emission light SL3 corresponding to the first image G1.

Voltages corresponding to the gradations indicated by the second sub pixel signals are applied to regions of the liquid crystal layer 33 corresponding to the second sub pixels SP2, and the liquid crystal molecules LM are tilted. The degree of tilt of the liquid crystal molecules LM changes with the gradations indicated by the second sub pixel signals. The first emission light SL1 and the second emission light SL2 transmitted through the regions of the liquid crystal layer 33 corresponding to the second sub pixels SP2 are modulated to the gradations indicated by the second sub pixel signals. In addition, the first emission light SL1 and the second emission light SL2 transmitted through the regions of the liquid crystal layer 33 corresponding to the second sub pixels SP2 are colored by being transmitted through the second color filters CF2. The first emission light SL1 and the second emission light SL2 transmitted through the liquid crystal panel 30 via the second color filters CF2 correspond to the second image G2.

Of the first emission light SL1 and the second emission light SL2 transmitted through the second color filters CF2, the first emission light SL1 travels in the first direction W1 and is blocked by the light-shielding part 37b. Accordingly, of the first emission light SL1 and the second emission light SL2 transmitted through the second color filters CF2, the first emission light SL1 traveling in the first direction W1 is not visual recognizable.

However, of the first emission light SL1 and the second emission light SL2 transmitted through the second color filters CF2, the second emission light SL2 travels in the second direction W2, passes through the openings 37a of the parallax barrier 37, and is externally emitted from the display surface 30a. Thus, the second emission light SL2 is visual recognizable as the second image G2. Accordingly, the liquid crystal panel 30 modulates the second emission light SL2 and displays the second image G2 on the display surface 30a.

In this manner, the parallax barrier 37 passes the first emission light SL1 transmitted through the first sub pixels SP1, passes the second emission light SL2 transmitted through the second sub pixels SP2, and blocks the second emission light SL2 transmitted through the first sub pixels SP1 and the first emission light SL1 transmitted through the second sub pixels SP2. With the parallax barrier 37, the viewing angle of the first image G1 and the viewing angle of the second image G2 are different from each other.

The viewer M illustrated in FIG. 1 directly visually recognizes the second image G2 on the display surface 30a. However, the viewer M cannot directly visually recognize the first image G1 on the display surface 30a.

The third emission light SL3 emitted from the display surface 30a travels in the first direction W1 toward the light-transmitting body 2 and is projected onto the light-transmitting body 2. The viewer M directing a sight line Lv to the third emission light SL3 projected onto the light-transmitting body 2, visually recognizes the first image G1 as the virtual image VG.

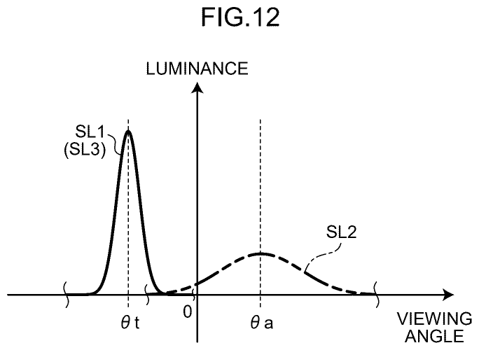

FIG. 12 is a diagram illustrating luminance distribution of the first emission light SL1 and the second emission light SL2. The vertical axis illustrated in FIG. 12 represents the luminance. The horizontal axis illustrated in FIG. 12 represents the viewing angle in the first panel direction DP1. The viewing angle of 0° means viewing the display surface 30a of the liquid crystal panel 30 in the third panel direction DP3.

An angle θt is the angle between the third panel direction DP3 and the first direction W1, and an angle θa is the angle between the third panel direction DP3 and the second direction W2 (refer to FIG. 1). The luminance and diffusion degree of the first emission light SL1 are equal to the luminance and diffusion degree of the third emission light SL3.

As described above, the luminance of the first emission light SL1 (third emission light SL3) is higher than the luminance of the second emission light SL2. Accordingly, it is possible to further improve the visibility of the virtual image VG corresponding to the first emission light SL1 (third emission light SL3) in the display device 1. Moreover, the viewer M can visually recognize the second image G2 at an appropriate brightness.

As described above, the diffusion degree of the second emission light SL2 is larger than the diffusion degree of the first emission light SL1 (third emission light SL3). Accordingly, the viewing angle of the second image G2 corresponding to the second emission light SL2 can be made larger than the viewing angle of the virtual image VG corresponding to the first emission light SL1. Thus, the viewer M can visually recognize the second image G2 appropriately.

Since the diffusion degree of the first emission light SL1 and the diffusion degree of the second emission light SL2 are adjusted, it is possible to ensure that the viewing angle of the first image G1 corresponding to the first emission light SL1 does not overlap the viewing angle of the second image G2 corresponding to the second emission light SL2. Accordingly, it is possible to prevent visual recognition of the first image G1 and the second image G2 in an overlapped state (what is called crosstalk) when the viewer M views the display surface 30a between the first panel direction DP1 and the second panel direction DP2.

In the first embodiment, the second light source device 20 does not need to include one of the first prism sheet 25 and the second prism sheet 26.

### Second Embodiment

The following describes the display device 1 according to a second embodiment of the present disclosure with focus on differences from the display device 1 of the above-described first embodiment.

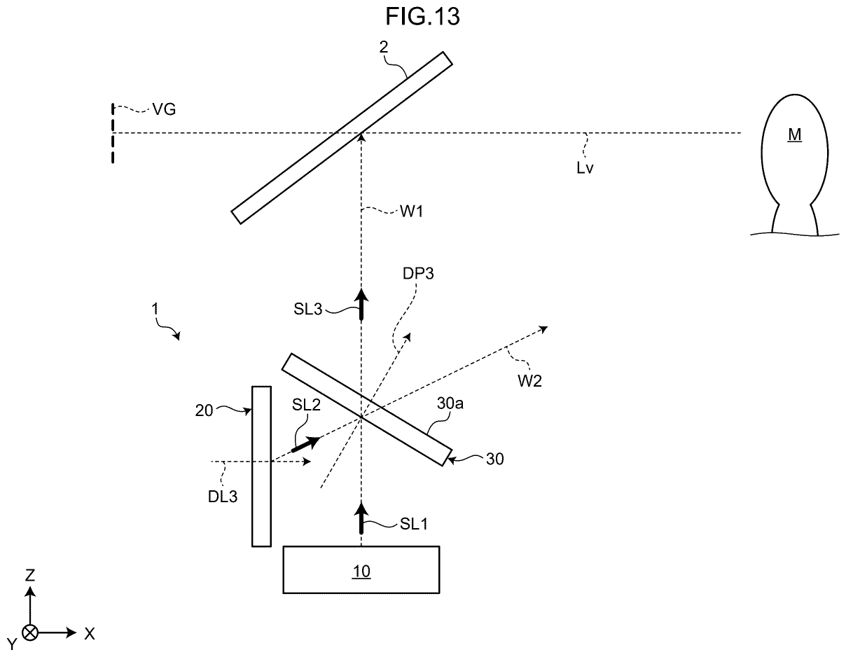

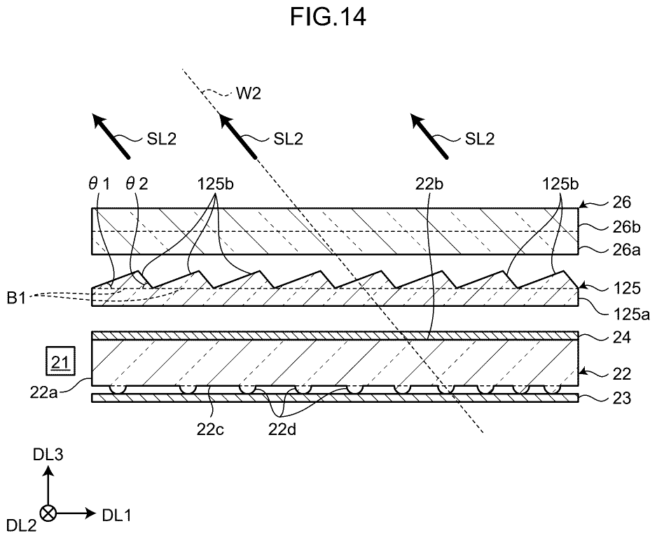

FIG. 13 is a schematic diagram of the display device 1 according to the second embodiment of the present disclosure. FIG. 14 is a sectional view of the second light source device 20 illustrated in FIG. 13.

In the second embodiment, the first plate surface 22b is tilted relative to the second direction W2. Accordingly, the second direction W2 is tilted relative to the third light source direction DL3. In the second embodiment, the second light source device 20 is disposed in a state in which the first plate surface 22b is parallel to the first direction W1. Specifically, the second light source device 20 is disposed in a state in which the third light source direction DL3 is orthogonal to the Z direction (state in which the first light source direction DL1 is parallel to the Z direction). This makes it possible to achieve downsizing of the display device 1.

The second light source device 20 of the second embodiment is different from the second light source device 20 of the above-described first embodiment in the shape of a first prism sheet 125. The first prism sheet 125 includes a plate-shaped first base part 125a and a plurality of first prism parts 125b.

In the sectional shape of each first prism part 125b, the first bottom angle θ1 is set to be smaller than the second bottom angle θ2. Accordingly, the first prism sheet 125 refracts the second light L2 traveling in the first light source direction DL1 into the second direction W2.

Similarly to the second prism sheet 26 of the above-described first embodiment, the second prism sheet 26 refracts the second light L2 in the second light source direction DL2 into the third light source direction DL3. In other words, the second prism sheet 26 refracts the second light L2 into the third light source direction DL3 when viewed along the first light source direction DL1.

In the second embodiment, the second light source device 20 do not need to include the second prism sheet 26.

Preferable embodiments of the present disclosure are described above, but the present disclosure is not limited to such embodiments. Contents disclosed in the embodiments are merely exemplary, and various kinds of modifications are possible without departing from the scope of the present disclosure. Any modification performed as appropriate without departing from the scope of the present disclosure belongs to the technical scope of the present disclosure.

For example, the first light source device 10 may be an edge-lit backlight. In this case, the first light source device 10 may be configured in the same manner as the second light source device 20.

The second light source device 20 may be a direct-type backlight. In this case, the second light source device 20 may be configured in the same manner as the first light source device 10.

The second light source device 20 does not need to include the diffusion sheet 24.

The diffusion degree of the second emission light SL2 may be equal to or smaller than the diffusion degree of the first emission light SL1.

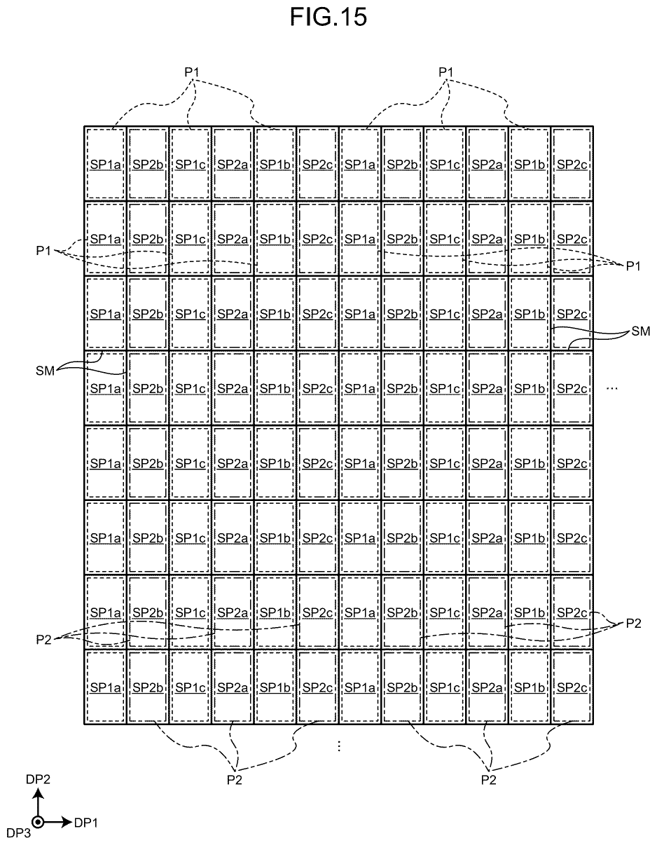

FIG. 15 is a diagram illustrating an arrangement of the first sub pixels SP1 and the second sub pixels SP2 of the liquid crystal panel 30 included in the display device 1 according to a modification of each embodiment of the present disclosure.

In the present modification, the first pixels P1 and the second pixels P2 are each disposed in the row direction (first panel direction DP1) and the column direction (second panel direction DP2). Focusing on the first pixels P1 arranged in the row direction, the first-type first sub pixel SP1a, the third-type first sub pixel SP1c, and the second-type first sub pixel SP1b are repeatedly disposed in the stated order in the row direction. Focusing on the second pixels P2 arranged in the row direction, the second-type second sub pixel SP2b, the first-type second sub pixel SP2a, and the third-type second sub pixel SP2c are repeatedly disposed in the stated order in the row direction.

Moreover, the first sub pixels SP1 and the second sub pixels SP2 are alternately arranged in the row direction. That is, the first sub pixel SP1 and the second sub pixel SP2 are adjacent to each other in the row direction. Specifically, the first-type first sub pixel SP1a is adjacent to at least one of the second-type second sub pixel SP2b and the third-type second sub pixel SP2c in the row direction. The second-type first sub pixel SP1b is adjacent to at least one of the third-type second sub pixel SP2c and the first-type second sub pixel SP2a in the row direction. The third-type first sub pixel SP1c is adjacent to at least one of the first-type second sub pixel SP2a and the second-type second sub pixel SP2b in the row direction.

The first-type second sub pixel SP2a is adjacent to at least one of the second-type first sub pixel SP1b and the third-type first sub pixel SP1c in the row direction. The second-type second sub pixel SP2b is adjacent to at least one of the third-type first sub pixel SP1c and the first-type first sub pixel SP1a in the row direction. The third-type second sub pixel SP2c is adjacent to at least one of the first-type first sub pixel SP1a and the second-type first sub pixel SP1b in the row direction.

The first sub pixels SP1 are disposed in the column direction. Specifically, the first-type first sub pixels SP1a are disposed in a state of being adjacent to each other in the column direction. The second-type first sub pixels SP1b are disposed in a state of being adjacent to each other in the column direction. The third-type first sub pixels SP1c are disposed in a state of being adjacent to each other in the column direction.

The second sub pixels SP2 are disposed in the column direction. Specifically, the first-type second sub pixels SP2a are disposed in a state of being adjacent to each other in the column direction. The second-type second sub pixels SP2b are disposed in a state of being adjacent to each other in the column direction. The third-type second sub pixels SP2c are disposed in a state of being adjacent to each other in the column direction.

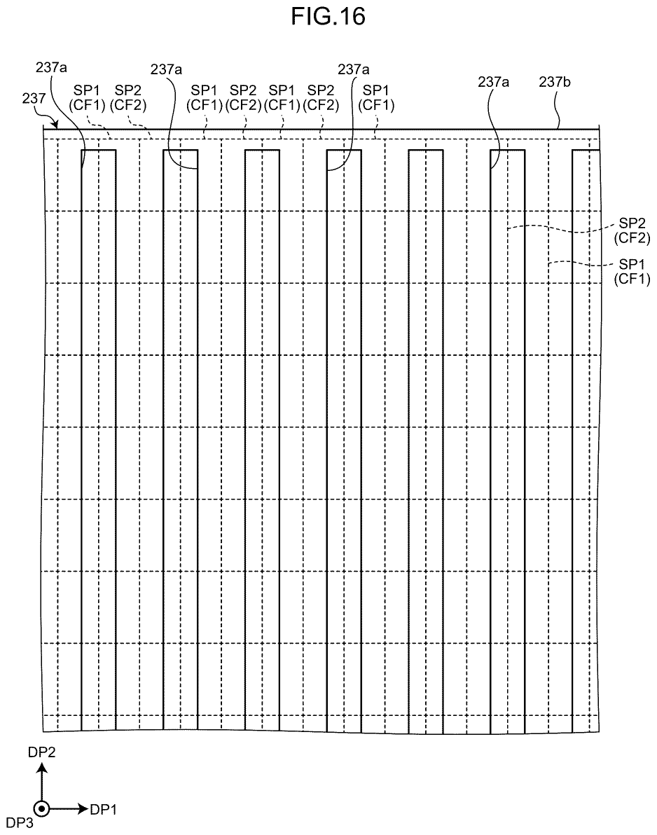

FIG. 16 is a plan view of a parallax barrier 237 of the liquid crystal panel 30 included in the display device 1 according to the modification of each embodiment of the present disclosure. The parallax barrier 237 of the present modification corresponds to the arrangement of the first sub pixels SP1 and the second sub pixels SP2 illustrated in FIG. 15. The parallax barrier 237 includes openings 237a and a light-shielding part 237b.

In FIG. 16, the first sub pixels SP1 and the second sub pixels SP2 are illustrated with dashed lines. In the present modification, each opening 237a overlaps one first color filter CF1 and one second color filter CF2 adjacent to each other in the row direction in plan view. In the plan view illustrated in FIG. 16, as in the above-described embodiment, each opening 237a overlaps the negative DP1 side of a first color filter CF1 and the positive DP1 side of a second color filter CF2.

Each opening 237a has a shape extending in the column direction (second panel direction DP2). Each opening 237a overlaps a plurality of first sub pixels SP1 arranged in the column direction and a plurality of second sub pixels SP2 arranged in the column direction in plan view. The openings 237a are disposed in the row direction (first panel direction DP1).

Since the first sub pixels SP1, the second sub pixels SP2, and the openings 237a are disposed as illustrated in FIGS. 15 and 16, the viewing angle of the first image G1 and the viewing angle of the second image G2 are different from each other as in the above-described embodiment. In the present modification as well, the first sub pixels SP1 and the second sub pixels SP2 are disposed across the entire display region DA. Accordingly, the first image G1 and the second image G2 are simultaneously displayed in the entire display region DA.

In the parallax barrier 37 illustrated in FIG. 16, each opening 237a may be formed so as to overlap one first sub pixel SP1 and one second sub pixel SP2 in the column direction in plan view. In this case, the openings 237a are disposed in each of the row direction (first panel direction DP1) and the column direction (second panel direction DP2).

It should be understood that the present disclosure provides any other effects achieved by aspects described above in the present embodiment, such as effects that are clear from the description of the present specification or effects that could be thought of by the skilled person in the art as appropriate.

What is claimed is:

1. A display device comprising:
a first light source device configured to emit first emission light in a first direction;
a second light source device configured to emit second emission light in a second direction different from the first direction; and
a liquid crystal panel on which the first emission light and the second emission light are incident, wherein
the liquid crystal panel is configured to
modulate the first emission light and emit, in the first direction, the modulated first emission light toward a light-transmitting body as third emission light corresponding to a first image, and
modulate the second emission light to display a second image on a display surface, and
luminance of the first emission light is higher than luminance of the second emission light.

2. The display device according to claim 1, wherein a diffusion degree of the second emission light is larger than a diffusion degree of the first emission light.

3. The display device according to claim 1, wherein the first light source device includes
a plurality of first light emitters configured to emit first light, and
a lens configured to refract the first light to align the light in the first direction, and to emit the light as the first emission light.

4. The display device according to claim 1, wherein the second light source device includes
a plurality of second light emitters configured to emit second light,
a light guiding member having a side plate surface on which the second light is incident and a plate surface from which the second light incident through the side plate surface is emitted, and
a prism sheet configured to refract the second light emitted from the plate surface to align the light in the second direction, and to emit the light as the second emission light.

5. The display device according to claim 4, wherein
the plate surface is tilted relative to the second direction, and
the second light source device is disposed in a state in which the plate surface is parallel to the first direction.

6. The display device according to claim 4, wherein the second light source device further includes a diffusion sheet disposed on the plate surface side.

7. The display device according to claim 1, wherein the liquid crystal panel
includes a plurality of first sub pixels corresponding to the first image and a plurality of second sub pixels corresponding to the second image, the first and second sub pixels being disposed in a matrix of rows and columns in a plan view, and
further includes a parallax barrier configured to pass the first emission light transmitted through the first sub pixels and the second emission light transmitted through the second sub pixels and to block the second emission light transmitted through the first sub pixels and the first emission light transmitted through the second sub pixels.
